(19) United States
(12) Patent Application Publication
(10) Pub. No.: US 2026/0370966 A1
(43) Pub. Date: Nov. 19, 2026

(54) IMAGE SENSOR AND METHOD FOR DITHERING COMPENSATION

(71) Applicant: Silicon Optronics, Inc., Hsinchu (TW)

(72) Inventors: Sheng-Yi PENG, Hsinchu (TW); Wei-Hsiu HUANG, Hsinchu (TW); Qingfeng LI, Hsinchu (TW)

(21) Appl. No.: 19/330,005

(22) Filed: Sep. 16, 2025

(30) Foreign Application Priority Data
May 19, 2025 (CN) 202510644787.3

(51) Int. Cl. H04N 25/611; H04N 25/13; H04N 25/633

(52) U.S. Cl. CPC H04N 25/611; H04N 25/134; H04N 25/633

(57) ABSTRACT

An image sensor that compensates its sensed and processed data using a dithering technology is shown. The data sensed by a sensing array is processed and then compensated for by the dithering technology based on pseudo-random patterns. In each pseudo-random pattern, pixels are randomly numbered with balanced probability. According to a threshold corresponding to the average quantization error, the pixels with pixel numbering lower than the threshold are compensated for by one digital number (DN).

### CROSS REFERENCE TO RELATED APPLICATIONS

This application claims priority of China patent application No. 202510644787.3 filed May, 19, 2025, the entirety of which is incorporated by reference herein.

### TECHNICAL FIELD

The present disclosure relates to image sensors, and in particular it relates to quantization error compensation for image sensors.

### BACKGROUND

Distortion may occur during the early processing stages employed by image sensors. Due to bit precision limitations, signal details that are smaller than a single digital number (DN) may be lost. This distortion may be amplified during back-end image processing, resulting in instabilities in color, brightness, and other aspects.

The conventional solution is to increase the number of output bits to improve precision. However, increasing the number of output bits directly affects the output bandwidth. Since the bandwidth of an image sensor is limited, this solution is not ideal.

How to solve quantization distortion without increasing costs and reducing system performance is an important issue in this technical field.

### BRIEF SUMMARY

This disclosure proposes an image rounding error compensation scheme that implements dithering compensation based on pseudo-random patterns. Accordingly, quantization errors are compensated for.

An image sensor in accordance with an exemplary embodiment of the disclosure has a sensing array, a signal processing circuit, and an output circuit. The sensing array senses images to generate sensed data. The signal processing circuit is coupled to the sensing array to receive and process the sensed data. The output circuit is coupled to the signal processing circuit to perform dithering compensation on the processed sensed data. Rather than using a fixed pattern, the dithering compensation is performed based on pseudo-random patterns. In each pseudo-random pattern, pixels are randomly numbered with balanced probability. The output circuit performs compensation of one digital unit for pixels with pixel numbering lower than a threshold, and the threshold depends on the average quantization error. In an exemplary embodiment, the output circuit includes a pseudo-random number generator that generates pseudo-random numbers for the pseudo-random numbering of pixels.

The concept of pseudo-random patterns is further used to implement a dithering compensation method for an image sensor. According to processed sensed data, which is sensed by a sensing array and then processed, dithering compensation is performed on the processed sensed data. The dithering compensation is performed based on pseudo-random patterns. In each pseudo-random pattern, the pixels are randomly numbered with balanced probability. Compensation of one digital unit is performed for pixels with pixel numbering lower than a threshold. The threshold depends on the average quantization error.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 shows an image sensor 100 in accordance with an exemplary embodiment of the disclosure;

FIG. 2 illustrates the pseudo-random number generator 110 in accordance with an exemplary embodiment of the disclosure, which includes a linear feedback shift register (LFSR) 200;

FIG. 3 illustrates a two-dimensional pseudo-random pattern generator 300 in accordance with an exemplary embodiment of the disclosure, which includes a first linear feedback shift register LFSR_col, a second linear feedback shift register LFSR_line, and a finite field conversion module finite_n_field;

FIG. 4 illustrates a three-dimensional pseudo-random pattern generator 400 in accordance with an exemplary embodiment of the disclosure; and

FIG. 5 shows a pseudo-random pattern dithering compensation method implemented in accordance with an exemplary embodiment of the disclosure.

### DETAILED DESCRIPTION

The following description shows various exemplary embodiments of the present disclosure, but is not intended to limit the content of the present disclosure. The actual scope of the disclosure should be defined in accordance with the appended claims. The various functional blocks described below may be implemented by a combination of hardware, software, and firmware, and may also include special circuits. The presented circuits, units, modules, or functional blocks are not limited to being implemented separately, but may be combined together to share certain structures.

Detail information within 1 digital number (DN) sensed by an image sensor is discarded during quantization. In the disclosure, the detail information is utilized in the statistical processing inside the image sensor. The discarded information is dispersed into a 2-dimensional image at the image output stage, which is named dithering compensation, operate to reduce the quantization errors. Particularly, the disclosed dithering compensation is performed based on pseudo-random patterns. Rather than distributing the discarded information across the image in a fixed pattern, the dithering compensation is performed on the image with balanced probability. In this manner, the dithering compensation effect is better.

In an exemplary embodiment, the dithering compensation requires numbering pixels to form a pixel numbering pattern. According to a threshold corresponding to the average quantization error, dithering compensation performs compensation of one digital unit (DN) for the pixels with pixel numbering lower than the threshold. As for the compensation direction, it depends on the quantization method (e.g., rounding, or truncation). When the quantization errors are rounded down, the data of the pixels with pixel numbering lower than the threshold is increased by one digital unit (+1 DN) through the dithering compensation. When the quantization errors are rounded up, the data of the pixels with pixel numbering lower than the threshold is decreased by one digital unit (−1 DN) through the dithering compensation.

In the conventional circuit design, a fixed pixel numbering pattern is used to implement the dithering compensation. One conventional pixel numbering pattern is a 4×4 matrix, which numbers the 16 pixels covered by the 4×4 pattern from 0 to 15. The conventional circuit applies this fixed 4×4 pixel numbering pattern through the entire sensed image to implement the dithering compensation. For example, if the detail information less than one digital unit is rounded down in the quantization, and the average quantization error of the entire sensed image is 3/16, then 3 is taken as the threshold. The data of pixels with pixel numbering 0~2 defined according to the 4×4 pixel numbering pattern is increased by 1 (+1 DN). By moving this 4×4 pixel numbering pattern cross the entire sensed image, dithering compensation, based on the fixed pixel numbering pattern, is performed on the entire sensed image is compensated for.

However, unlike the conventional circuit that uses a fixed pixel numbering pattern to implement the dithering compensation, this disclosure uses a pseudo-random number generator (PRNG) to number the image pixels. In this disclosure, the dithering compensation is performed based on pseudo-random patterns. In each pseudo-random pattern, the pixels are randomly numbered, by the numbers within a specific range, with balanced probability. In this manner, the dithering effect is more similar to white noise, and the noise average is controllable.

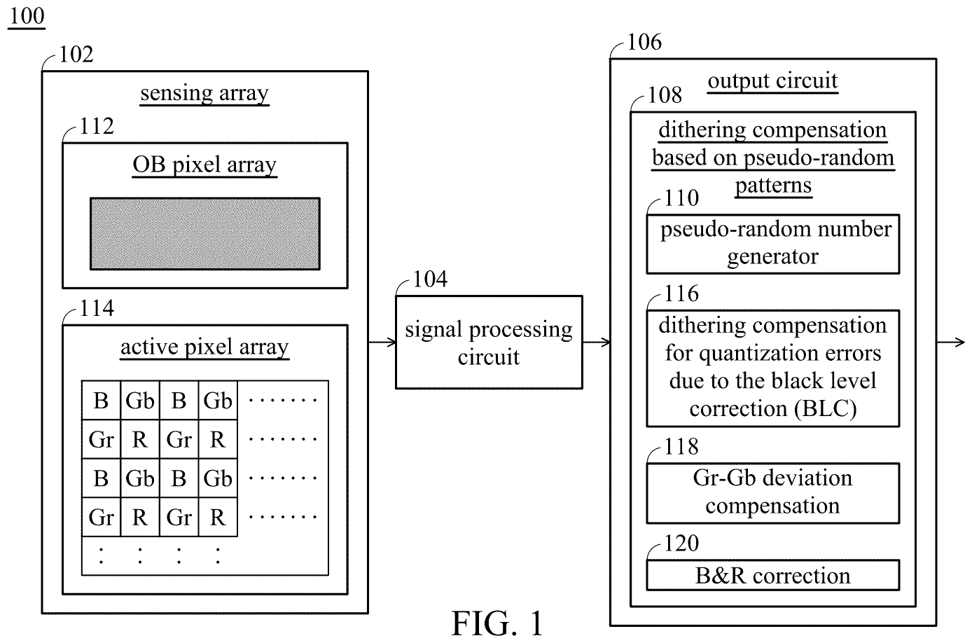

FIG. 1 shows an image sensor 100 in accordance with an exemplary embodiment of the disclosure, which includes a sensing array (e.g., a CMOS image sensing array) 102, a signal processing circuit 104, and an output circuit 106. The sensing array 102 senses images to generate sensed data. The signal processing circuit 104 processes the sensed data for noise removal, quantization, etc. The output circuit 106 includes implementing a functional block 108 to perform dithering compensation, using pseudo-random patterns, on the processed sensed data. The pixel numbering in each pattern is non-fixed. In each pseudo-random pattern, pixels are randomly numbered with balanced probability. Based on the pseudo-random patterns, compensation of one digital unit is performed for pixels with pixel numbering lower than a threshold. The threshold depends on the average quantization error. The effect is far superior to using a fixed pixel numbering pattern. The functional block 108 includes a pseudo-random number generator 110 that generates pseudo-random numbers to number the pixels to form the pseudo-random patterns.

The sensing array 102 includes an optical black pixel array (also called OB pixel array) 112 as well as an active pixel array 114 for color sensing. The output circuit 106 may operate the functional block 108 to perform dithering compensation with pseudo-random patterns on the active pixel array 114 based on quantization errors caused by black level correction of the OB pixel array 112.

Additionally, the output circuit 106 may further operates the functional block 108 to perform dithering compensation with pseudo-random patterns on the active pixel array 114 based on Gr-Gb channel deviation. The active pixel array 114 includes four color sensing pixels arranged in a Bayer pattern. In the Bayer pattern, there are blue (B) pixels, red (R) pixels, green (Gb) pixels arranged with blue (B) pixels of the same row in an interleaved way; and green (Gr) pixels arranged with red (R) pixels of the same row in an interleaved way. The sensed data of the four types of pixels are separately transferred and processed through four channels. The two types of green pixels (Gr, Gb) in separate channels will have sensing errors, creating a need for Gr-Gb compensation. Similar Bayer multi-channel design is also used for the OB pixel array 112. Although the color sensing of the OB pixel array 112 is shieled by a metal, there are still deviations between the different channels. Thus, the Gr-Gb deviation compensation can also be applied on the OB pixel array 112. In an exemplary embodiment, the output circuit 106 operates the functional block 108 to separate the pseudo-random dithering compensation for the blue data (B), red data (R), first green data (Gb), and second green data (Gr). The illustration (108) shows that the dithering compensation using pseudo-random patterns may correspond to the different error factors. The dithering compensation for quantization errors of black level correction (BLC) is 116. The Gr-Gb deviation compensation considering dithering compensation is 118. The blue (B)/red (R) correction considering dithering compensation is 120.

Corresponding to the OB pixel array 112, the pseudo-random number generator 110 operates to generate pseudo-random patterns for the dithering compensation (116) for the quantization errors due to the black level correction (BLC) of the OB pixel array 112. Referring to 118, considering the deviations between the two types of green pixels Gb and Gr of the active pixel array 114, the pseudo-random patterns for dithering compensation for Gb and the pseudo-random patterns for dithering compensation for Gr are separately generated by the pseudo-random number generator 110. Referring to 120, to correct the blue pixels B and red pixels R of the active pixel array 114, the pseudo-random patterns for dithering compensation for the blue pixels B and the pseudo-random patterns for dithering compensation for the red pixels R are separately generated by the pseudo-random number generator 110.

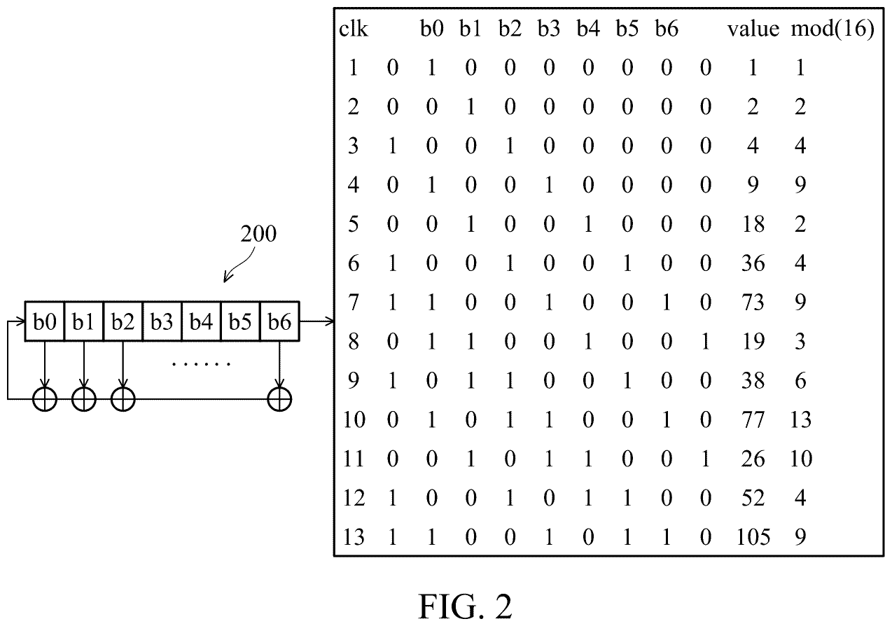

FIG. 2 illustrates the pseudo-random number generator 110 in accordance with an exemplary embodiment of the disclosure, which includes a linear feedback shift register (LFSR) 200. The illustrated linear feedback shift register 200 is a 7-bit design (b0~b6) that generates a cyclic sequence, including values in the 0~(2⁷−1) range, based on a clock signal clk. Through a finite field conversion, such as taking the remainder (mod) or taking partial bits (bitwise), random numbers with the same occurrence probability are obtained, which are so-called pseudo-random numbers. According to the operation mod(16), the remainder is within a range of 0~15; each appearing with the same probability, and regarded as a pseudo-random number within the 0~15 range. Pseudo-random patterns formed by pixels numbered with such pseudo-random numbers will bring effective dithering compensation.

In an exemplary embodiment, the pixels in the first line are numbered in sequence from the left to the right of the array by the pseudo-random numbers generated based on the clock signal clk. Then, the pixel numbering proceeds to the next line. In an exemplary embodiment, the scrambling seed for the generation of pseudo-random numbers is changed when the pixel numbering proceeds to the next line. In this manner, the pixel numbering of the different lines is not fixed. In an exemplary embodiment, the scrambling seed is further changed when the pixel numbering proceeds to the next frame. In this manner, the pixel numbering of the different frames is not fixed. The scrambling seed may have various implementations. In an exemplary embodiment, another linear feedback shift register (LFSR) is required to generate the scrambling seed.

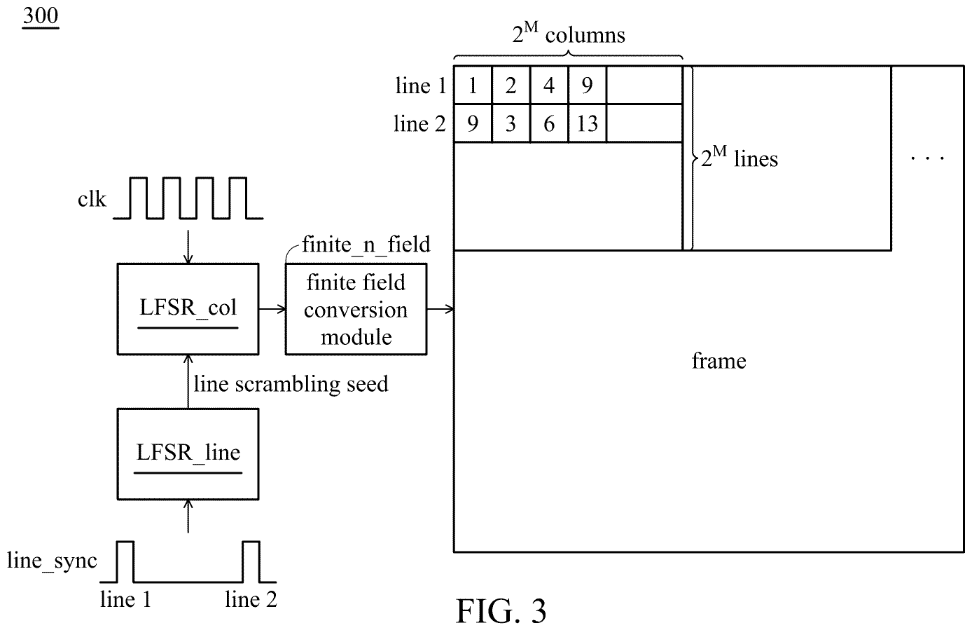

FIG. 3 illustrates a two-dimensional pseudo-random pattern generator 300 in accordance with an exemplary embodiment of the disclosure, which includes a first linear feedback shift register LFSR_col, a second linear feedback shift register LFSR_line, and a finite field conversion module finite_n_field. The first and second linear feedback shift registers LFSR_col and LFSR_line each is an M-bit design, randomly generating pseudo-random numbers from 0~(2^{M}−1) with balanced probability. The first linear feedback shift register LFSR_col shifts its data according to the clock signal clk, and is operated to implement the pseudo-random pixel numbering between the different columns. The second linear feedback shift register LFSR_line shifts its data according to a line synchronization signal line_sync, and is operated to provide the line scrambling seeds to the first linear feedback shift register LFSR_col to implement the pseudo-random pixel numbering between the different lines (rows). After converting the numbers 0~(2^{M}−1) to 0~n through the finite field conversion module finite_n_field, the pixels in each 2^{M}×2^{M} area of the array are numbered 0~n with balanced probability. Referring to the average quantization error ±k/(n+1) of the entire pixel array, k is regarded as the threshold. Pixels with pixel numbering less than the threshold k are compensated for by ±1 digital unit (DN). In an exemplary embodiment, the dithering compensation is performed on each pixel just after its pixel numbering. Thus, the system performance is high.

The illustrated first and second linear feedback shift registers LFSR_col and LFSR_line are 7-bit designs. Based on the line synchronization signal line_sync of line 1, the second linear feedback shift register LFSR_line provides a line scrambling seed corresponding to line 1 to the first linear feedback shift register LFSR_col, making the first linear feedback shift register LFSR_col generate pseudo-random numbers from 0~127, which are converted to numbers 0~15 (taking modulo 16) through the finite field conversion module finite_n_field, becoming the illustrated 1, 3, 4, 9, . . . , pixel numbering of the first line. If the average quantization error of the entire array is + 5/16 (the average rounded-down value is 5/16 DN), the first three pixels of line 1 with pixel numbering less than 5 each is compensated for by +1 DN for dithering compensation. The 4ₜₕ pixel numbered 9 is greater than 5, so it is not compensated for. Such pseudo-random numbering (in the 0~15 range) corresponding to 128 pixels and compensation are repeated until the end of the 1^{st} line. Next, based on the line synchronization signal line_sync of line 2, the second linear feedback shift register LFSR_line provides a line scrambling seed corresponding to line 2 to the first linear feedback shift register LFSR_col, making the first linear feedback shift register LFSR_col generate another sequence of 0~127 pseudo-random numbers for line 2. After being converted by the finite field conversion module finite_n_field, the pixel numbering for line 2 is: 9, 3, 6, 13, . . . , which are indeed different from the pixel numbering for line 1.

The design operating the second linear feedback shift register LFSR_line to provide line scrambling seeds to the first linear feedback shift register LFSR_col makes the pixel numbering of the entire array more random, and the dithering compensation effect is better.

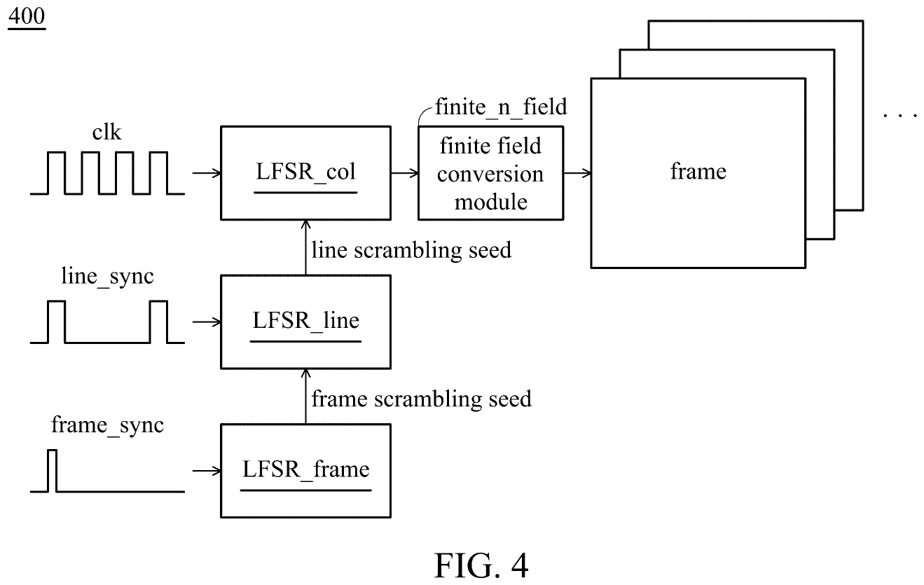

FIG. 4 illustrates a three-dimensional pseudo-random pattern generator 400 in accordance with an exemplary embodiment of the disclosure. Compared to FIG. 3, the pseudo-random pattern generator 400 further operates a third linear feedback shift register LFSR_frame. Based on a frame synchronization signal frame_sync, the third linear feedback shift register LFSR_frame provides a frame scrambling seed to the second linear feedback shift register LFSR_line. In this way, the different frames correspond to the different pixel numbering, high randomness is achieved, and the dithering compensation effect is better.

In an exemplary embodiment, to compensate for the quantization errors of black level correction, the pseudo-random pattern generator 300/400 provides a dedicated set of linear feedback shift registers. In an exemplary embodiment, the pseudo-random patterns for the different channels of sensed data are separately arranged. Corresponding to the four color channels (R/B/Gr/Gb) for the Bayer arrangement of the active pixel array 114, the pseudo-random pattern generator 300/400 provides dedicated four sets of linear feedback shift registers.

Based on the aforementioned pseudo-random number pattern concept, a dithering compensation method for the image sensor 100 is proposed.

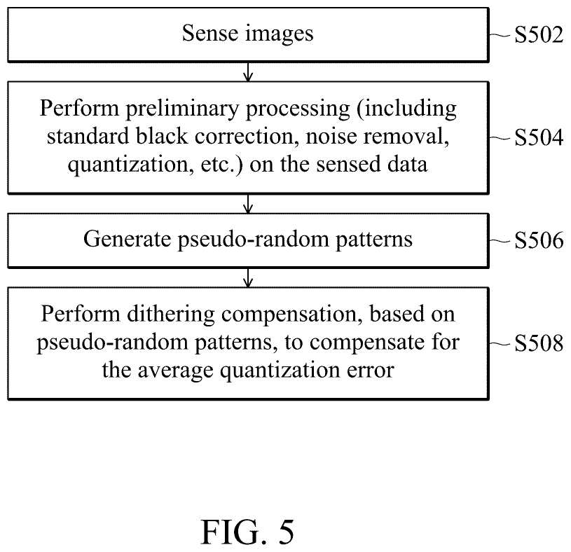

FIG. 5 shows a pseudo-random pattern dithering compensation method implemented in accordance with an exemplary embodiment of the disclosure. In step S502, the sensing array 102 senses images. In step S504, the signal processing circuit 104 performs preliminary processing (including standard black correction, noise removal, quantization, etc.) on the sensed data received from the sensing array 102. In step S506, the pseudo-random number generator 110 operates to generate pseudo-random patterns. In step S508, dithering compensation is performed based on pseudo-random patterns to compensate for the average quantization error.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. An image sensor, comprising:
a sensing array, sensing images to generate sensed data;
a signal processing circuit, coupled to the sensing array to receive and process the sensed data; and
an output circuit, coupled to the signal processing circuit to perform dithering compensation on the processed sensed data, wherein the dithering compensation is performed based on pseudo-random patterns, and in each pseudo-random pattern, pixels are randomly numbered with balanced probability,
wherein the output circuit performs compensation of one digital unit for pixels with pixel numbering lower than a threshold, and the threshold depends on an average quantization error.

2. The image sensor as claimed in claim 1, wherein the output circuit comprises:
a pseudo-random number generator, generating pseudo-random numbers for pseudo-random numbering of pixels.

3. The image sensor as claimed in claim 2, wherein the pseudo-random number generator comprises:
a first linear feedback shift register, generating numbers according to a clock signal for the pseudo-random numbering of the pixels.

4. The image sensor as claimed in claim 3, wherein the pseudo-random number generator further comprises:
a finite field conversion module, converting the numbers generated by the first linear feedback shift register to a smaller finite range to generate the pseudo-random numbers within the finite range for the pseudo-random numbering of the pixels.

5. The image sensor as claimed in claim 3, wherein the pseudo-random number generator changes a scrambling seed of the first linear feedback shift register according to a line synchronization signal.

6. The image sensor as claimed in claim 5, wherein the pseudo-random number generator comprises:
a second linear feedback shift register, operated according to the line synchronization signal to generate a line scrambling seed as the scrambling seed of the first linear feedback shift register.

7. The image sensor as claimed in claim 6, wherein the pseudo-random number generator changes a scrambling seed of the second linear feedback shift register according to a frame synchronization signal.

8. The image sensor as claimed in claim 7, wherein the pseudo-random number generator comprises:
a third linear feedback shift register, operated according to the frame synchronization signal to generate a frame scrambling seed as the scrambling seed of the second linear feedback shift register.

9. The image sensor as claimed in claim 1, wherein:
the sensing array includes an optical black pixel array and an active pixel array for color sensing; and
the output circuit performs the dithering compensation with pseudo-random patterns according to quantization errors of black level correction of the optical black pixel array.

10. The image sensor as claimed in claim 9, wherein:
the active pixel array is in a Bayer arrangement, and generates blue data, red data, first green data, and second green data, wherein sensors of the first green data are adjacent to sensors of the blue data, and sensors of the second green data are adjacent to sensors of the red data; and
the output circuit separately performs the dithering compensation with pseudo-random patterns on the red data, the blue data, the first green data, and the second green data.

11. A method for dithering compensation for an image sensor, comprising:
receiving processed sensed data, which is sensed by a sensing array and then processed;
performing dithering compensation on the processed sensed data, wherein the dithering compensation is performed based on pseudo-random patterns, and in each pseudo-random pattern, pixels are randomly numbered with balanced probability, wherein
compensation of one digital unit is performed for pixels with pixel numbering lower than a threshold, and the threshold depends on an average quantization error.

12. The method as claimed in claim 11, further comprising:
operating a pseudo-random number generator to generate pseudo-random numbers for pseudo-random numbering of pixels.

13. The method as claimed in claim 12, further comprising:
operating a first linear feedback shift register to generate numbers according to a clock signal for the pseudo-random numbering of the pixels.

14. The method as claimed in claim 13, further comprising:
converting the numbers generated by the first linear feedback shift register to a smaller finite range to generate the pseudo-random numbers within the finite range for the pseudo-random numbering of the pixels.

15. The method as claimed in claim 13, further comprising:
changing a scrambling seed of the first linear feedback shift register according to a line synchronization signal.

16. The method as claimed in claim 15, further comprising:
operating a second linear feedback shift register according to the line synchronization signal to generate a line scrambling seed as the scrambling seed of the first linear feedback shift register.

17. The method as claimed in claim 16, further comprising:
changing a scrambling seed of the second linear feedback shift register according to a frame synchronization signal.

18. The method as claimed in claim 17, further comprising:
operating a third linear feedback shift register according to the frame synchronization signal to generate a frame scrambling seed as the scrambling seed of the second linear feedback shift register.

19. The method as claimed in claim 11, wherein:
the sensing array includes an optical black pixel array and an active pixel array for color sensing; and
the dithering compensation with pseudo-random patterns is performed according to quantization errors of black level correction of the optical black pixel array.

20. The method as claimed in claim 19, wherein:
the active pixel array is in a Bayer arrangement, and generates blue data, red data, first green data, and second green data, wherein sensors of the first green data are adjacent to sensors of the blue data, and sensors of the second green data are adjacent to sensors of the red data; and
the dithering compensation with pseudo-random patterns is separately performed on the red data, the blue data, the first green data, and the second green data.
